(19) United States
(12) Patent Application Publication
(10) Pub. No.: US 2018/0369967 A1
(43) Pub. Date: Dec. 27, 2018

(54) BRAZING FLUXES AND METHODS FOR PRODUCING BRAZING FLUXES

(71) Applicant: HONEYWELL INTERNATIONAL INC., Morris Plains, NJ (US)

(72) Inventors: Elisabeth Memmel, Seelze (DE); Jessica Maurer, Wunstorf (DE); Christian Werner, Hannover (DE)

(73) Assignee: HONEYWELL INTERNATIONAL INC., Morris Plains, NJ (US)

(21) Appl. No.: 16/009,642

(22) Filed: Jun. 15, 2018

Related U.S. Application Data
(60) Provisional application No. 62/524,156, filed on Jun. 23, 2017.

(51) Int. Cl. B23K 35/362; C01F 7/54

(52) U.S. Cl. CPC B23K 35/362; C01F 7/54

(57) ABSTRACT

Non-hygroscopic brazing fluxes, methods for producing non-hygroscopic brazing fluxes, and methods for producing hydrated cesium aluminum fluorides are provided. An exemplary method for producing a non-hygroscopic brazing flux includes preparing a mixture including aluminum, cesium, and fluorine. The prepared mixture has an aluminum:cesium:fluorine molar ratio of about (1):(1.1-1.2):(4.0-4.2). The method further includes drying the mixture at a temperature higher than about 90° C. to form a product comprising at least about 20 mass percent hydrated cesium aluminum fluoride, based on the total mass of the product.

### CROSS-REFERENCE TO RELATED APPLICATION

This application claims the benefit of priority to U.S. provisional patent application Ser. No. 62/524,156, filed on Jun. 23, 2017, titled “BRAZING FLUXES AND METHODS FOR PRODUCING BRAZING FLUXES”, the contents of which are herein incorporated by reference in their entirety.

### TECHNICAL FIELD

The technical field generally relates to brazing fluxes and to methods for producing brazing fluxes. More particularly, the technical field relates to cesium aluminum fluorides and the production of cesium aluminum fluorides for use in brazing fluxes.

### BACKGROUND

Structural components may be joined together using known methods such as brazing, welding, and soldering. Brazing is a method of joining two pieces of similar or dissimilar metal together through use of a molten filler material, typically with a melting temperature of from about 425° C. to about 550° C. Welding is typically performed at a high temperature and melts similar metals to be joined such that the two similar metals are fused together. On the other hand, soldering is typically performed at a low temperature, such as below 450° C., with a solder material.

While brazed and welded joints provide for strong bonding, they may be utilized in different manners. For example, welding may be selected for localized joints while brazing may be selected for joining components at joints of larger areas or when joining dissimilar materials having different melting points.

When a brazing process is performed in a non-reducing atmosphere, such as in air, a brazing flux composition or compound (referred to as a “brazing flux”) is used to clean any contamination from the brazing surfaces of each component, i.e., the surfaces to be joined. Specifically, the brazing flux eliminates existing oxides and/or inhibits the formation of oxides on the brazing surfaces. During the brazing process, the components to be joined are positioned adjacent one another such that the brazing surfaces define a small gap. The brazing flux and a filler material are contacted to the brazing surfaces and the brazing surfaces are heated to a temperature above the melting point of the brazing flux and the filler material, but below the melting point of the components. As a result, the brazing flux and filler material melt. The melted brazing flux wets the brazing surfaces and flows through the gap between the components via capillary action, as does the filler material.

When the filler material cools, the filler material hardens to form a metallurgical bond between the brazing surfaces of the joined components. The metallurgical bond may be formed between similar or dissimilar metals, alloys, and/or ceramics. Ceramic components may be coated with metals or alloys prior to brazing.

Accordingly, it is desirable to provide improved brazing fluxes for use in brazing processes. Further, it is desirable to provide methods for producing brazing fluxes. Also, it is desirable to provide methods for producing hydrated cesium aluminum fluorides for use in brazing processes. Furthermore, other desirable features and characteristics will become apparent from the subsequent detailed description and the appended claims, taken in conjunction with the accompanying drawings and this background.

### BRIEF SUMMARY

Non-hygroscopic brazing fluxes, methods for producing non-hygroscopic brazing fluxes, and methods for producing hydrated cesium aluminum fluorides are provided. A method for producing a non-hygroscopic brazing flux includes preparing a mixture including aluminum, cesium, and fluorine. The exemplary mixture has an aluminum:cesium:fluorine molar ratio of about (1):(1.1-1.2):(4.0-4.2). The method further includes drying the mixture at a temperature higher than about 90° C. to form a product including at least about 20 mass percent hydrated cesium aluminum fluoride, based on the total mass of the product.

In another exemplary embodiment, a method for producing hydrated cesium aluminum fluorides is provided. The method for producing hydrated cesium aluminum fluorides includes combining aluminum oxide (Al₂O₃) and hydrofluoric acid (HF). The method includes forming tetrafluoroaluminic acid (HAlF₄). Further, the method includes mixing cesium hydroxide (CsOH) with the tetrafluoroaluminic acid (HAlF₄) to form a mixture. Also, the method includes spray drying the mixture to form a product including at least about 20 mass percent hydrated cesium aluminum fluoride, based on the total mass of the product.

In another embodiment, a non-hygroscopic brazing flux is provided. The exemplary non-hygroscopic brazing flux includes about 30 to about 70 mass percent hydrated cesium tetrafluoroaluminate (CsAlF₄.H₂O)₂), based on the total mass of the non-hygroscopic brazing flux. Further, the exemplary non-hygroscopic brazing flux includes about 10 to about 40 mass percent hydrated cesium pentafluoroaluminate (Cs₂AlF₅.H₂O), based on the total mass of the non-hygroscopic brazing flux.

### BRIEF DESCRIPTION OF THE DRAWINGS

The various embodiments will hereinafter be described in conjunction with the following drawing figures, wherein like numerals denote like elements, and wherein:

FIG. 1 is a schematic view of an apparatus for performing a method for producing a brazing flux in accordance with an embodiment herein.

FIG. 2 is a block diagram depicting a manufacturing line for production of a brazing ring with integrated brazing flux in accordance with an embodiment herein;

FIG. 3 is a perspective view of an extruded tube having the profile of a brazing ring in accordance with an embodiment herein;

FIG. 4 is a perspective view of the extruded tube of FIG. 3 with flux integrated into channels therein; and

FIG. 5 is a perspective view of a brazing ring with integrated brazing flux depicted in accordance with an embodiment herein.

### DETAILED DESCRIPTION

The following detailed description is merely exemplary in nature and is not intended to limit the brazing fluxes or methods for producing brazing fluxes. Furthermore, there is no intention to be bound by any theory presented in the preceding background or the following detailed description.

As described herein, non-hygroscopic brazing fluxes and methods for producing non-hygroscopic brazing fluxes are provided. As described, the brazing flux is formed with an increased ratio of desired crystal structures, i.e., high water crystal structures such as hydrated cesium tetrafluoroaluminate (CsAlF₄.(H₂O)₂) and hydrated cesium pentafluoroaluminate (Cs₂AlF₅.H₂O). Therefore, the brazing flux produced is less vulnerable to water takeup, such as in wet or humid conditions.

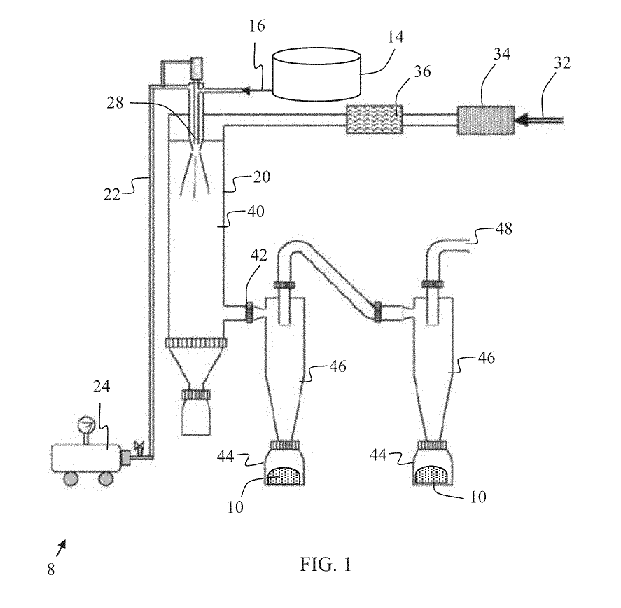

Referring to FIG. 1, an exemplary apparatus 8 for performing a method for producing a non-hygroscopic brazing flux product 10 is illustrated. The apparatus 8 includes a container or vessel 14 in which a mixture 16 may be formed from selected components. An exemplary mixture 16 includes aluminum, cesium, and fluorine, as well as water. Further, the exemplary method includes forming the mixture with a selected aluminum:cesium:fluorine molar ratio. For example, the aluminum:cesium:fluorine molar ratio may be about (1):(1-1.5):(3.5-4.5). In certain embodiments, the aluminum:cesium:fluorine molar ratio may be about (1):(1.1-1.2):(4.0-4.2), such as about (1):(1.15-1.20):(4.10-4.15).

In an exemplary embodiment, the mixture is formed by combining aluminum oxide (Al₂O₃) and hydrofluoric acid (HF) and forming tetrafluoroaluminic acid (HAlF₄). Further, the exemplary mixture is formed by mixing cesium hydroxide (CsOH) with the tetrafluoroaluminic acid (HAlF₄).

The method for producing the non-hygroscopic brazing flux product 10 may further include increasing the pH of the mixture 16 to a pH of from about 4.5 to about 9 before spray drying. For example, the method may include increasing the pH of the mixture to a pH of from about 7 to about 8 before spray drying. In an exemplary embodiment, the method includes increasing the pH of the mixture 16 before spray drying by adding cesium hydroxide (CsOH) to the mixture 16 in the vessel 14.

In an exemplary embodiment, the mixture 16 is pre-treated before undergoing spray drying. For example, the mixture 16 may be cooled down from the elevated reaction temperature. In an exemplary embodiment, the mixture is cooled down to a temperature of from about 30° C. to about 50° C., such as to a temperature of about 40° C. As shown, the mixture 16 is delivered to a spray drying unit 20. In the spray drying unit 20, the mixture 16 may be atomized through contact with a pressurized gas stream 22 flowing from a compressor 24 to an atomizer 28, for example rotary discs. In an exemplary embodiment, the pressurized gas stream 22 is air.

As further shown, another gas stream 32 is introduced into the spray drying unit 20. Specifically, gas stream 32, such as an air stream, is filtered by passing through a particular filter 34. Further, gas stream 32 is heated by passing through heater 36. Then, the heated gas stream 32 is introduced into the spray drying unit 20.

The mixture 16, pressurized gas stream 22 and heated gas stream 32 pass through the atomizer 28 into a drying chamber 40 in the spray drying unit 20 at a selected inlet temperature. For example, the inlet temperature may be higher than about 200° C., such as from about 200° C. to about 400° C. In certain embodiments, the inlet temperature is from about 220° C. to about 300° C., such as from about 240° C. to about 280° C. In certain embodiments, the inlet temperature is less than about 275° C., such as less than about 270° C., for example less than about 260° C. Heating the mixture 16 to such low temperatures may allow the desired crystal structure to remain stable.

Passing through the atomizer 28 at the selected inlet temperature causes formation of brazing flux in the form of dried particulate or powder 10. A stream of the dried particulate and gas may pass out of the drying chamber 40 through outlet 42. In an exemplary embodiment, the temperature of the stream including the dried particulate 10 and the gas at the outlet 42 is from about 80° C. to about 150° C. For example, the temperature of the stream at the outlet 42 may be from about 90° C. to about 125° C., such as from about 105° C. to about 115° C.

As shown in FIG. 1, the dried particulate form of the brazing flux 10 may be collected in receivers 44 located below cyclones 46. Further, air 48 may be removed from the cyclones 46 for re-use in the apparatus 8.

By drying the mixture 16 gently at a temperature higher than about 90° C., such as higher than about 105° C., the brazing flux product 10 includes at least about 20 mass percent hydrated cesium aluminum fluorides, based on the total mass of the product 10. An exemplary brazing flux product 10 includes at least about 50 mass percent hydrated cesium aluminum fluoride, based on the total mass of the product. Further, an exemplary brazing flux product 10 includes at least about 30 mass percent hydrated cesium tetrafluoroaluminate (CsAlF₄.(H₂O)₂), based on the total mass of the product. In an exemplary embodiment, the brazing flux product 10 includes at least about 30 mass percent hydrated cesium tetrafluoroaluminate (CsAlF₄.(H₂O)₂) and at least about 10 mass percent hydrated cesium pentafluoroaluminate (Cs₂AlF₅.H₂O), based on the total mass of the product.

In an exemplary embodiment, the product 10 is formed with a composition of from about 6 to about 12 mass percent aluminum, based on the total mass of the product. An exemplary product 10 is formed with a composition of from about 9 to about 10 mass percent aluminum, based on the total mass of the product. Further, the exemplary product 10 is formed with a composition of from about 50 to about 70 mass percent cesium, based on the total mass of the product. An exemplary product 10 is formed with a composition of from about 58 to about 61 mass percent cesium, based on the total mass of the product. Also, the exemplary product 10 is formed with a composition of from about 20 to about 40 mass percent fluorine, based on the total mass of the product. An exemplary product 10 is formed with a composition of from about 29 to 31 mass percent fluorine, based on the total mass of the product.

In the process of FIG. 1, the brazing flux product 10 may be formed with a composition of from about 30 to about 70 mass percent hydrated cesium tetrafluoroaluminate (CsAlF₄.(H₂O)₂), based on the total mass of the brazing flux. In an exemplary embodiment, the brazing flux product 10 includes from about 35 to about 60 mass percent hydrated cesium tetrafluoroaluminate (CsAlF₄.(H₂O)₂), based on the total mass of the brazing flux. For example, the brazing flux may include from about 36 to about 56 mass percent hydrated cesium tetrafluoroaluminate (CsAlF₄.(H₂O)₂), based on the total mass of the brazing flux.

Further, the exemplary brazing flux product 10 may be formed with a composition of from about 10 to about 40 mass percent hydrated cesium pentafluoroaluminate (Cs₂AlF₅.H₂O), based on the total mass of the brazing flux. In an exemplary embodiment, the brazing flux product 10 includes from about 15 to about 30 mass percent hydrated cesium pentafluoroaluminate (Cs₂AlF₅.H₂O), based on the total mass of the brazing flux. For example, the brazing flux product 10 may include from about 15 to about 25 mass percent hydrated cesium pentafluoroaluminate (Cs₂AlF₅.H₂O), based on the total mass of the brazing flux.

Also, the brazing flux product 10 may include hydrated cesium hydroxide (Cs(OH).(H₂O)₂). For example, the brazing flux product 10 may be formed with a composition of less than about 10 mass percent hydrated cesium hydroxide (Cs(OH).(H₂O)₂), based on the total mass of the brazing flux. In an exemplary embodiment, the brazing flux product 10 includes less than about 5 mass percent hydrated cesium hydroxide (Cs(OH).(H₂O)₂), based on the total mass of the brazing flux. For example, the brazing flux product 10 may include from about 0 to about 3 mass percent hydrated cesium hydroxide (Cs(OH).(H₂O)₂), based on the total mass of the brazing flux.

Further, the brazing flux product 10 may include (hexagonal) cesium tetrafluoroaluminate (CsAlF₄). For example, the brazing flux product 10 may be formed with a composition of less than about 15 mass percent cesium tetrafluoroaluminate (CsAlF₄), based on the total mass of the brazing flux. In an exemplary embodiment, the brazing flux product 10 includes less than about 10 mass percent cesium tetrafluoroaluminate (CsAlF₄), based on the total mass of the brazing flux. For example, the brazing flux product 10 may include from about 0 to about 6 mass percent cesium tetrafluoroaluminate (CsAlF₄), based on the total mass of the brazing flux.

The exemplary brazing flux product 10 may include other components. For example, the brazing flux product 10 may include from about 0 to about 30 mass percent of other components, based on the total mass of the brazing flux.

### Example

In an example, a method for producing a non-hygroscopic brazing flux is performed as a batch process. In the method, 5500 liters of water are fed into a vessel. The method includes adding 850 kg of Al₂O₃ to the water in the vessel. Further, the method includes adding 1180 kg of HF solution having a concentration of 76% to the water in the vessel. Also, the method includes adding 3686 kg of CsOH solution having a concentration of 51.3% to the water in the vessel.

The method includes stirring the components in the mixture for four hours. Then, the pH of the mixture is monitored. In the example, the pH is desired at a range of from about 4.5 to about 9, such as from about 7 to about 8. If the pH is too low, it may be adjusted by adding CsOH to attain a pH in the desired range.

Thereafter, the brazing flux product is isolated by spray drying, such as in a spray drying apparatus as described in relation to FIG. 1. In the example, the inlet temperature of the spray drying apparatus is from about 240 to about 280° C., such as about 250° C., and the outlet temperature of the spray drying apparatus is from about 90° C. to about 125° C., such as from about 105 to about 115° C.

As a result of the process in the example, the brazing flux product is formed with a composition of from about 58 to about 61 mass percent cesium, from about 9 to about 10 mass percent aluminum, and from about 29 to about 31 mass percent fluorine.

The example forms the brazing flux product with the following crystal phase composition: from about 36 to about 56 mass percent hydrated cesium tetrafluoroaluminate (CsAlF₄.(H₂O)₂), based on the total mass of the brazing flux; from about 15 to about 25 mass percent hydrated cesium pentafluoroaluminate (Cs₂AlF₅.H₂O), based on the total mass of the brazing flux; from about 0 to about 3 mass percent hydrated cesium hydroxide (Cs(OH).(H₂O)₂), based on the total mass of the brazing flux; from about 0 to about 6 mass percent cesium tetrafluoroaluminate (CsAlF₄), based on the total mass of the brazing flux; and from about 0 to about 30 mass percent of other components, based on the total mass of the brazing flux.

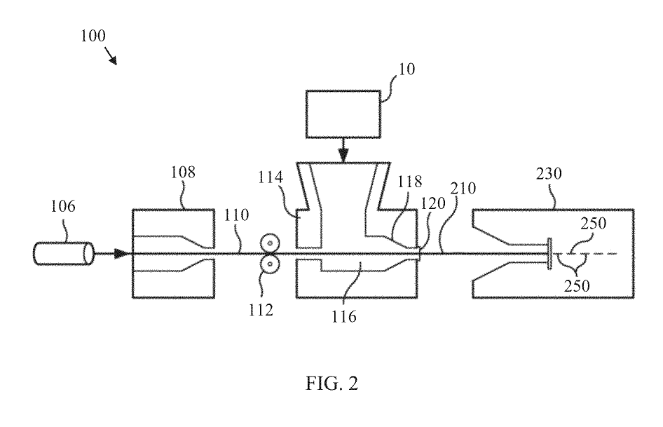

As described herein, brazing fluxes may be produced for use in brazing processes. In an exemplary embodiment, a brazing flux may be produced and molded with a filler material in a selected three dimensional shape, such as in the shape of a ring, by forming the brazing flux as a powder and by machining the powder. Other geometries or shapes may be formed as is known in the art, such as C-shaped filler with an inlaid single flux string. Exemplary filler materials include, for example, metals like aluminum, nickel, cobalt, copper, silver, zinc, lead, and non-metals like silicon and phosphorous, and combinations thereof, including alloys, however any desired filler materials might be used in embodiments herein. With additional reference now to FIGS. 2-5, an apparatus 100 for producing a brazing ring 250 is described in accordance with an embodiment. Initially a billet 106 of filler material is provided. The billet 106 can be produced by any methods known in the art and has a composition desired in the final brazing ring. The billet 106 might also include one or more alloying elements or additives and/or be subjected to one or more heat treatments or other processes to impart material characteristics desired in the brazing ring or to facilitate manufacturing. Although a billet 106 is described herein, the filler materials might be in the form of powders, ingots, bars, or the like.

As shown, the apparatus 100 includes an extrusion press 108. The billet 106 is extruded by the extrusion press 108, through a die (not shown) to form a pipe or tube 110, as best depicted by FIG. 3. In an embodiment, the billet 106 is heated to about 500° C. for extrusion. Extrusion of the billet 106 to form the tube 110 is completed by techniques known in the art. Following extrusion, the tube 110 might be heat treated or otherwise processed to impart desired material properties. In an embodiment, the tube 110 is cooled from an extrusion temperature of about 500° C. to about 450° C. at a controlled rate within about 2 minutes after extrusion.

As shown, the apparatus 100 includes straightening and/or forming rolls 112, hereinafter collectively referred to as rolls 112. The tube 110 is also passed through one or more rolls 112. The rolls 112 provide straightening of deformities in the tube 110 that occur during extrusion or subsequent processing. The rolls 112 can also provide additional forming of the tube 110 to produce a desired profile. Additionally, the rolls 112 might act as drive rolls to drive the tube 110 along its path to the next stage of processing. In an embodiment, the rolls 112 receive the tube 110 directly from the extrusion press 106 during or after extrusion thereof.

The apparatus 100 further includes a filling device 114. An exemplary filling device 114 includes a reservoir 116 containing the brazing flux 10. In an embodiment, the reservoir 116 is pressurized and includes a conical portion 118 leading to an exit aperture 120. As shown, the tube 110 is advanced to the filling device 114 and is driven through the reservoir 116 containing the brazing flux 10.

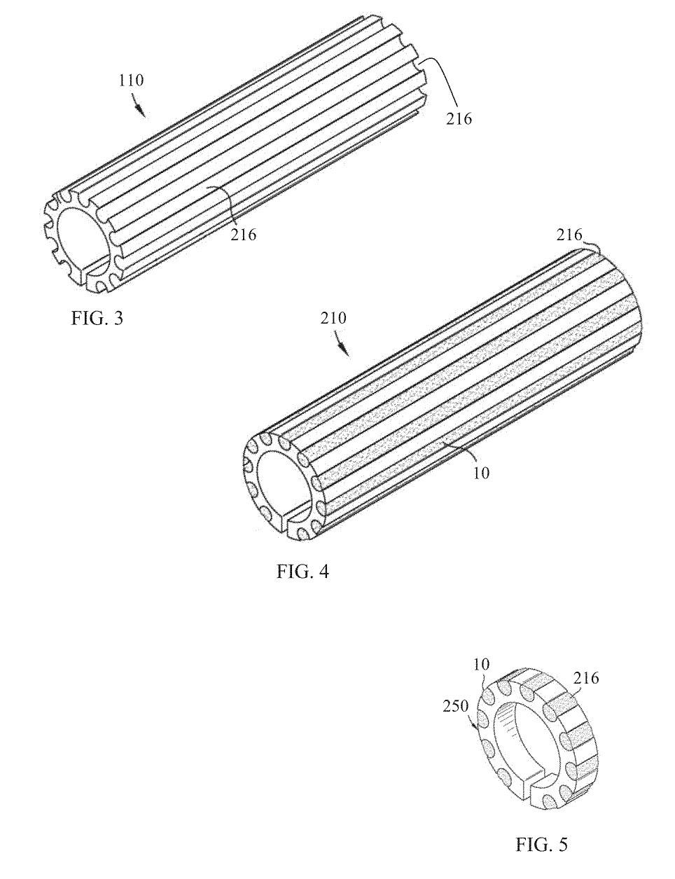

The pressurization of the reservoir 116 forces the brazing flux 10 into the channels 216 of tube 110 as the tube 110 passes through the reservoir 116 to produce a tube 210 with integrated flux, as best depicted in FIG. 4. The tube 210 is identical to the tube 110 but for the addition of the brazing flux 10 in the channels 216 thereof.

The apparatus 100 may further include a sectioning apparatus 230. As shown, the tube 210 is subsequently passed to the sectioning apparatus 230 wherein the tube 210 is sectioned transverse to its length to form the brazing rings 250, as depicted in FIG. 5. The sectioning apparatus 230 employs any cutting technology including, circular saw blade, band saws, knives, laser cutting, water-jet, shears, or the like. The sectioning apparatus 230 is configured to section the tube 210 to produce the brazing rings 250 in any desired thickness. The brazing rings 250 can be further processed to remove cutting debris, to apply additional brazing flux 10 to the cut faces of the brazing rings 250, to package the brazing rings 250 for transport, or the like.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the subject matter in any way. Rather, the foregoing detailed description will provide those skilled in the art with a convenient road map for implementing an exemplary embodiment. It being understood that various changes may be made in the function and arrangement of elements described in an exemplary embodiment without departing from the scope as set forth in the appended claims.

What is claimed is:

1. A method for producing a non-hygroscopic brazing flux, the method comprising:
preparing a mixture including aluminum, cesium, and fluorine, wherein the mixture has an aluminum:cesium:fluorine molar ratio of about (1):(1.1-1.2):(4.0-4.2); and
drying the mixture at a temperature higher than about 90° C. to form a product comprising at least about 20 mass percent hydrated cesium aluminum fluoride, based on the total mass of the product.

2. The method of claim 1 wherein drying the mixture at a temperature higher than about 90° C. comprises drying the mixture at a temperature of from about 90° C. to about 280° C.

3. The method of claim 1 wherein preparing the mixture comprises preparing the mixture with an aluminum:cesium:fluorine molar ratio of about (1):(1.15-1.20):(4.10-4.15).

4. The method of claim 1 wherein drying the mixture forms the product with a composition of about:
6 to 12 mass percent aluminum;
50 to 70 mass percent cesium; and
20 to 40 mass percent fluorine, based on the total mass of the product.

5. The method of claim 1 wherein drying the mixture forms the product with a composition of about:
9 to 10 mass percent aluminum;
58 to 61 mass percent cesium; and
29 to 31 mass percent fluorine, based on the total mass of the product.

6. A method for producing hydrated cesium aluminum fluorides, the method comprising:
combining aluminum oxide (Al₂O₃) and hydrofluoric acid (HF);
forming tetrafluoroaluminic acid (HAlF₄);
mixing cesium hydroxide (CsOH) with the tetrafluoroaluminic acid (HAlF₄) to form a mixture; and
spray drying the mixture to form a product comprising at least about 20 mass percent hydrated cesium aluminum fluorides, based on the total mass of the product.

7. The method of claim 6 further comprising increasing the pH of the mixture to a pH of from about 4.5 to about 9 before spray drying.

8. The method of claim 6 further comprising increasing the pH of the mixture to a pH of from about 7 to about 8 before spray drying.

9. The method of claim 6 further comprising increasing the pH of the mixture before spray drying by adding cesium hydroxide (CsOH) to the mixture.

10. The method of claim 6 wherein spray drying the mixture comprises heating the mixture by passing the mixture through an inlet having a temperature of from about 200° C. to about 400° C.

11. The method of claim 6 wherein spray drying the mixture comprises passing the mixture through an inlet having a temperature of from about 220° C. to about 300° C.

12. The method of claim 6 wherein spray drying the mixture comprises passing the mixture through an inlet having a temperature of from about 240° C. to about 280° C.

13. The method of claim 6 wherein spray drying the mixture comprises passing the mixture through an inlet having a temperature of from about 200° C. to about 400° C. and through an outlet having a temperature of from about 80° C. to about 150° C.

14. The method of claim 6 wherein spray drying the mixture comprises passing the mixture through an inlet having a temperature of from about 240° C. to about 280° C. and through an outlet having a temperature of from about 90° C. to about 125° C.

15. The method of claim 6 wherein spray drying the mixture forms the product comprising at least about 50 mass percent hydrated cesium aluminum fluoride, based on the total mass of the product

16. The method of claim 6 wherein spray drying the mixture forms the product comprising at least about 30 mass percent hydrated cesium tetrafluoroaluminate (CsAlF₄(H₂O)₂), based on the total mass of the product.

17. The method of claim 6 wherein spray drying the mixture forms the product comprising at least about 30 mass percent hydrated cesium tetrafluoroaluminate (CsAlF₄.(H₂O)₂) and at least about 10 mass percent hydrated cesium pentafluoroaluminate (Cs₂AlF₅.H₂O), based on the total mass of the product.

18. A non-hygroscopic brazing flux comprising:
about 30 to about 70 mass percent hydrated cesium tetrafluoroaluminate (CsAlF₄.(H₂O)₂), based on the total mass of the non-hygroscopic brazing flux; and
about 10 to about 40 mass percent hydrated cesium pentafluoroaluminate (Cs₂AlF₅.H₂O), based on the total mass of the non-hygroscopic brazing flux.

19. The non-hygroscopic brazing flux of claim 18, wherein the non-hygroscopic brazing flux comprises:
about 35 to about 60 mass percent hydrated cesium tetrafluoroaluminate (CsAlF₄.(H₂O)₂), based on the total mass of the non-hygroscopic brazing flux; and
about 15 to about 30 mass percent hydrated cesium pentafluoroaluminate (Cs₂AlF₅.H₂O), based on the total mass of the non-hygroscopic brazing flux.

20. The non-hygroscopic brazing flux of claim 18, wherein the non-hygroscopic brazing flux comprises:
about 36 to about 56 mass percent hydrated cesium tetrafluoroaluminate (CsAlF₄.(H₂O)₂), based on the total mass of the non-hygroscopic brazing flux; and
about 15 to about 25 mass percent hydrated cesium pentafluoroaluminate (Cs₂AlF₅.H₂O), based on the total mass of the non-hygroscopic brazing flux.
